(19) United States
(12) Patent Application Publication
(10) Pub. No.: US 2018/0117429 A1
(43) Pub. Date: May 3, 2018

(54) GOLF TRAINING AID APPARATUS

(71) Applicant: Andrew Graziano, Lethbridge (CA)

(72) Inventor: Andrew Graziano, Lethbridge (CA)

(21) Appl. No.: 15/800,038

(22) Filed: Oct. 31, 2017

Related U.S. Application Data
(60) Provisional application No. 62/415,782, filed on Nov. 1, 2016.

(51) Int. Cl. A63B 57/30; G01B 3/10

(52) U.S. Cl. CPC A63B 57/30; A63B 2220/13; G01B 3/1084

(57) ABSTRACT

An apparatus having an elongate body made of a piece of fabric having a plurality of different colored segments. The device provides a golf training aid that assists users in developing distance control and strengthening their chipping and putting game. The apparatus for use as a golf training aid includes a piece of fabric; the piece of fabric may have an elongate body with a first end and a second end. A plurality of grommets may be included.

### CROSS REFERENCE TO RELATED APPLICATION

The present application is related to and claims priority to U.S. Provisional Patent Application Number 62/415,782 filed Nov. 1, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of golf accessories and more specifically relates to a golf training aid.

### 2. Description of Related Art

Many people enjoy playing golf. Golf is a club and ball sport in which players use various clubs to hit balls into a series of holes on a course in as few strokes as possible. A golf club is used to hit a golf ball. Each club is composed of a shaft with a grip and a club head. Many golfers desire a way to improve their chip shot, as well as their putting game. With improved rhythm and tempo, players can achieve consistency. This will ultimately reduce their strokes on the green and strengthen their game overall. A training aid that affords players the ability to improve their shots is needed. Therefore, a suitable solution is desired.

U.S. Pat. No. 8,968,113 to John R Spelman, et al. relates to a golf putting trainer device. The described golf putting trainer device includes a device for assisting and training golfers with their putts. The device includes an elongated section configured to be placed on the ground where the golfer intends to make his back-swing for a selected put. A vertical section or “backstop” is configured to be placed at selected locations along the elongated section to corresponding to different putt lengths, and therefore different back-swing lengths. A distance scale may be printed on the elongated section. Light projection devices may be included to project a predicted ball path. A back-swing speed indicator system may also be included.

### BRIEF SUMMARY OF THE INVENTION

In view of the foregoing disadvantages inherent in the known golf art, the present disclosure provides a novel golf training aid apparatus. The general purpose of the present disclosure, which will be described subsequently in greater detail, is to provide a golf training aid that assists users in developing distance control and strengthening in their chipping and putting game.

An apparatus for use as a golf training aid is disclosed herein. The apparatus for use as a golf training aid includes a piece of fabric; the piece of fabric may have an elongate body with a first end and a second end. A plurality of grommets may be included. A first of the plurality of grommets may be located on the first end of the elongate body and a seventh of the plurality of grommets may be located on the second end of the elongate body. The elongate body may define a predetermined length. Furthermore, the elongate body may include a plurality of different colored segments which may be configured to represent a different distance interval. Each of the plurality of different colored segments may be separated by a second, a third, a fourth, a fifth, and a sixth of said plurality of grommets. In a preferred embodiment, the elongate body is 30 feet in length and has each of the plurality of different colored segments measuring 5 feet long. In an alternative embodiment, the elongate body is 90 feet in length and has each of the plurality of different colored segments measuring 15 feet in length. The present disclosure may be advantageous in providing the apparatus that may be configured to be used as a golf training aid and improve golfing skills by utilizing the above stated features, such as the plurality of different colored segments, during golf play.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a golf training aid apparatus, constructed and operative according to the teachings of the present disclosure.

FIG. 1 is a perspective view of the apparatus for use as a golf training aid during an ‘in-use’ condition, according to an embodiment of the disclosure.

FIG. 2 is a perspective view of the apparatus for use as a golf training aid of FIG. 1, according to an embodiment of the present disclosure.

FIG. 3 is a front perspective view of the apparatus for use as a golf training aid of FIG. 1, according to an embodiment of the present disclosure.

FIG. 4 is a perspective view of a portable carrier of FIG. 1, according to an embodiment of the present disclosure.

FIG. 5 is a perspective view of a device of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to golf and more particularly to a golf training aid apparatus as used to improve golf playing skills.

Generally, the present disclosure provides a golf training aid that assists users in developing distance control and strengthening their chipping and putting game. It improves a user's rhythm, tempo, and consistency to help save strokes on the green. This allows users to practice a variety of chip shots, and may also be used for putting distance control. It affords users a way to improve their game in their backyard, at a driving range, on the putting green, at the park, and anywhere else desired. The present disclosure offers virtually endless games and drills for users of all golfing abilities.

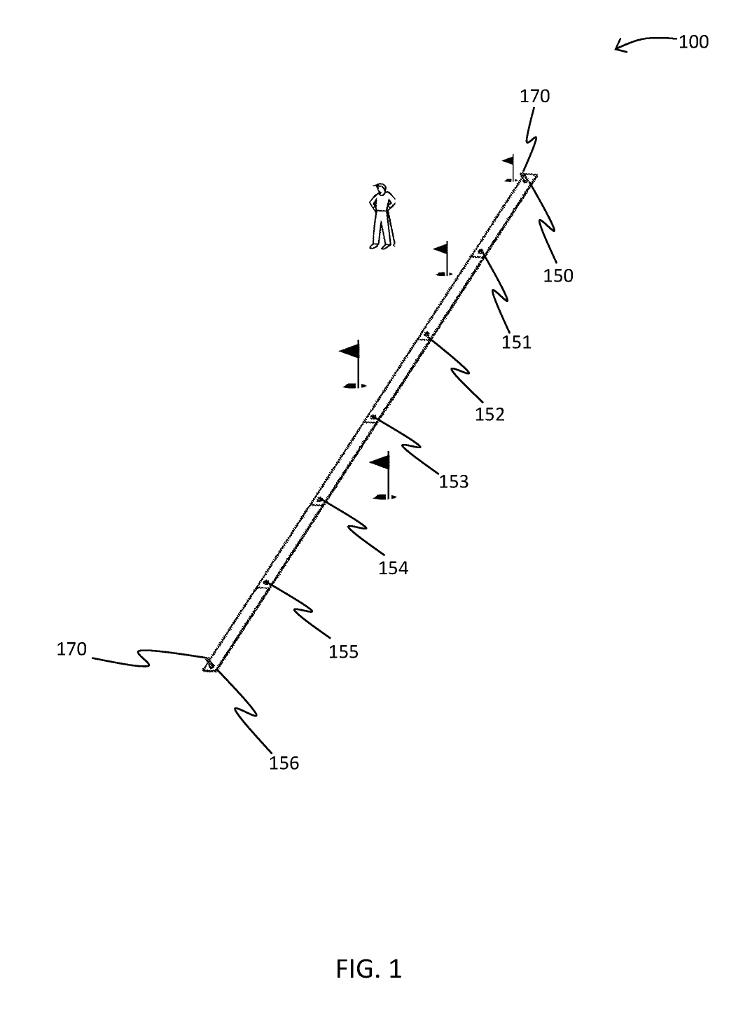

Referring now more specifically to the drawings by numerals of reference, there is shown in FIGS. 1-5, various views of an apparatus for use as a golf training aid 100. FIG. 1 shows an apparatus for use as a golf training aid 100 according to an embodiment of the present disclosure. As illustrated, the apparatus for use as a golf training aid 100 may include a piece of fabric 110. The piece of fabric 110 may have an elongate body 120 with a first end 130 and a second end 140. The elongate body 120 may define a predetermined length. The predetermined length may be between about 30 feet and 90 feet. Further, the elongate body 120 may include a plurality of different colored segments 160. Each of the plurality of different colored segments 160 may be configured to represent a different distance interval. Each of said plurality of different colored segments may be separated by a second 151, a third 152, a fourth 153, a fifth 154, and a sixth 155 of said plurality of grommets. Such a feature may be advantageous in improving golfing skills and providing a golf training aid.

The piece of fabric 110 may comprise of a polyester webbing, polypropylene, and/or nylon. The apparatus 100 may primarily be utilized outdoors. In order to protect the piece of fabric 110 from weather, the piece of fabric 110 may be UV-resistant, mold-resistant, and weatherproof.

The apparatus 100 may further include a plurality of grommets. A first 150 of the plurality of grommets may be located on the first end 130 of the elongate body 120, and a seventh 156 of the plurality of grommets may be located on the second end 140 of the elongate body 120. The apparatus 100 may further comprise a plurality of stakes 170. The plurality of stakes 170 may be removably coupled to the plurality of grommets and configured to secure the piece of fabric 110 to a portion of ground during use.

According to one embodiment, the apparatus for use as a golf training aid 100 may be arranged as a kit. The kit may include the apparatus for use as a golf training aid 100. The instructions may detail functional relationships in relation to the structure of the apparatus for use as a golf training aid 100 (such that the apparatus for use as a golf training aid 100 can be used, maintained, or the like, in a preferred manner).

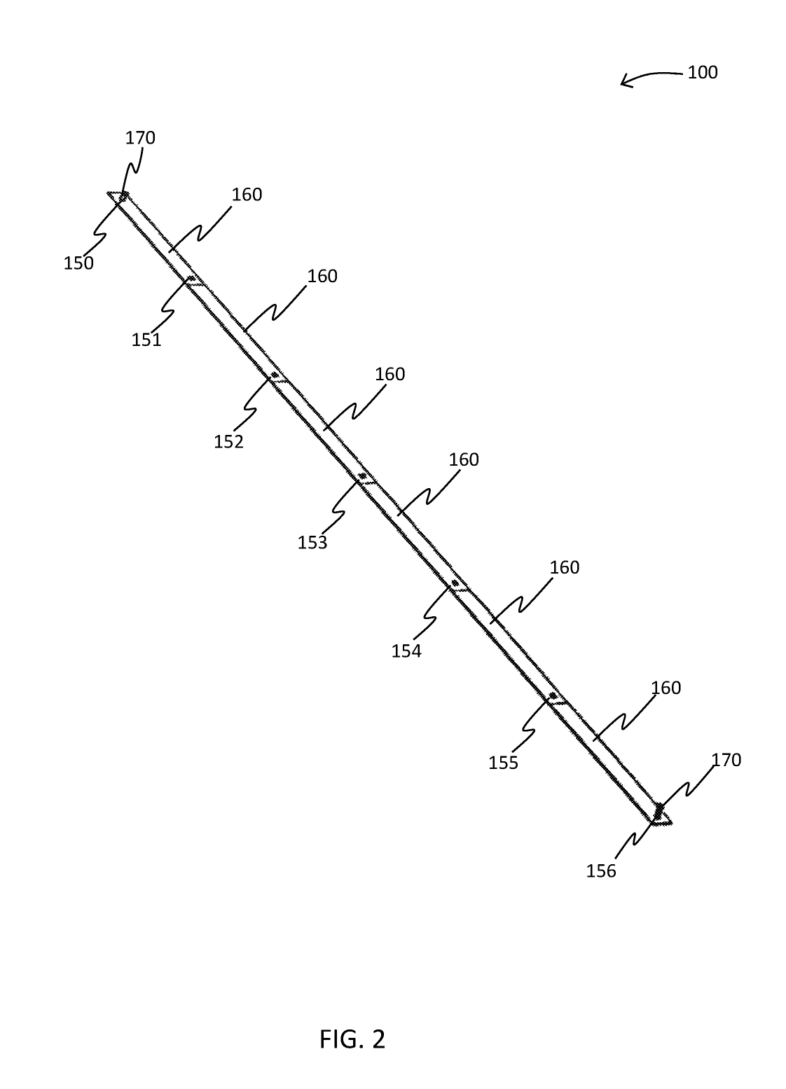

FIG. 2 shows a perspective view of the apparatus for use as a golf training aid 100 of FIG. 1, according to an embodiment of the present disclosure. As above, the apparatus for use as a golf training aid 100 may include and the piece of fabric 110. The piece of fabric 110 may have the elongate body 120 with the first end 130 and the second end 140. The elongate body 120 may include the plurality of different colored segments 160. Each of the plurality of different colored segments 160 may be configured to represent a different distance interval. The plurality of different colored segments 160 may comprise 6 different colored segments.

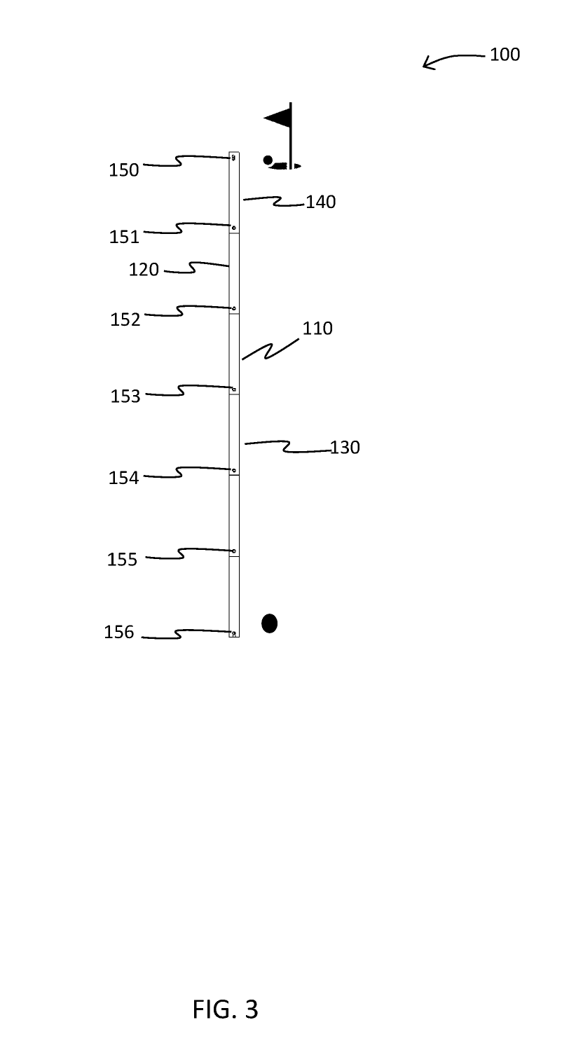

FIG. 3 shows a perspective view of the apparatus for use as a golf training aid 100 of FIG. 1, according to an embodiment of the present disclosure. As above, the apparatus for use as a golf training aid 100 may include the piece of fabric 110. The piece of fabric 110 may have the elongate body 120 with the first end 130 and the second end 140. The elongate body 120 may define the predetermined length. Dimensions of the piece of fabric 110 may include the predetermined length being between about 30 feet and 90 feet and a width between about 1 inch and 3 inches.

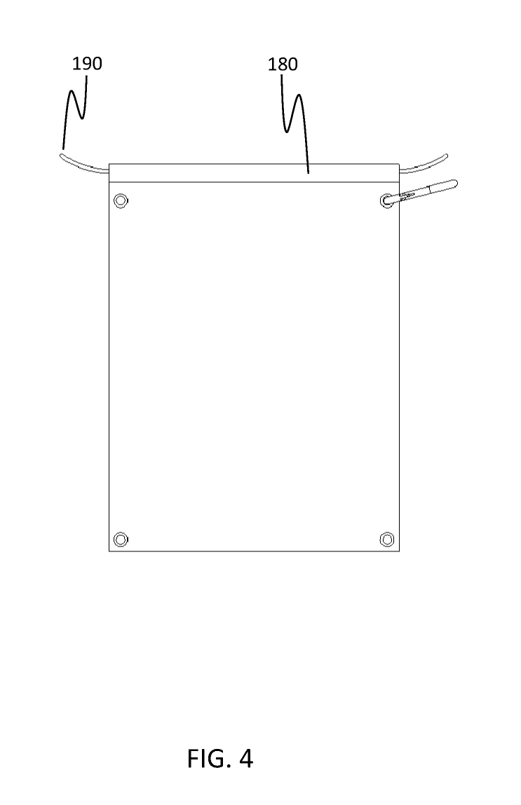

FIG. 4 shows a perspective view of the apparatus for use as a golf training aid 100 of FIG. 1, according to an embodiment of the present disclosure. As above, the apparatus for use as a golf training aid 100 may include and the piece of fabric 110. The apparatus 100 may further include a portable carrier 180 configured to house the apparatus 100 when not in use. The portable carrier 180 may include an attachment means 190 (i.e., strap, loop, etc.) configured to attach the portable carrier 180 to a golf club carrier.

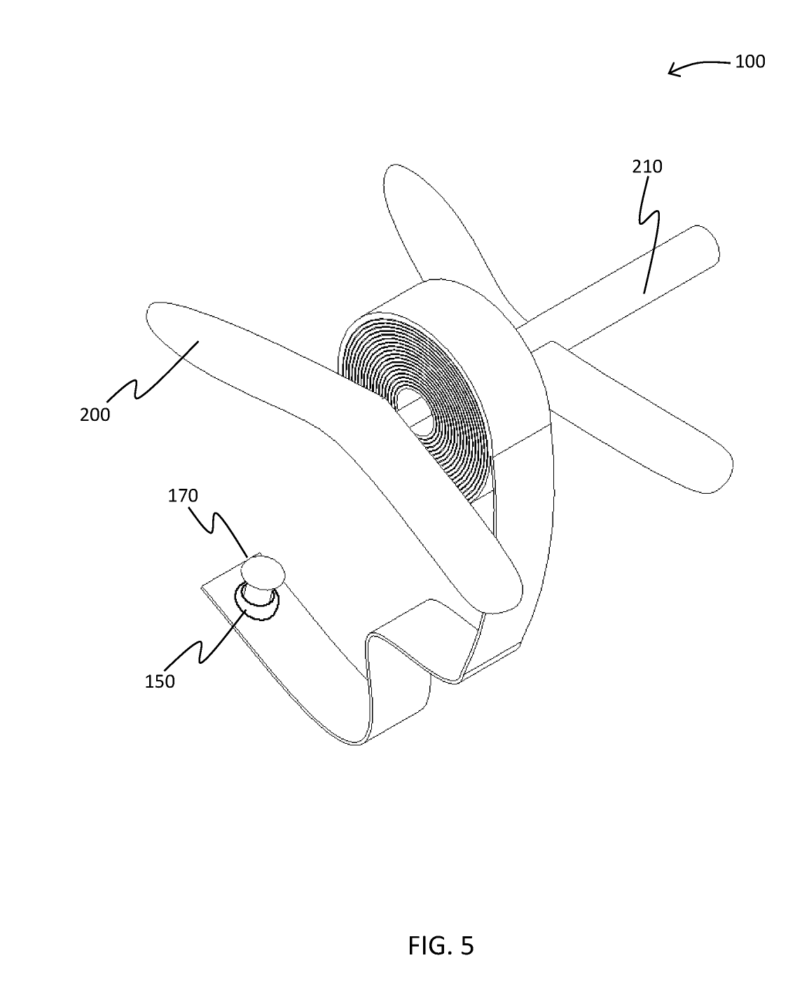

FIG. 5 shows a perspective view of the apparatus for use as a golf training aid 100 of FIG. 1, according to an embodiment of the present disclosure. As above, the apparatus for use as a golf training aid 100 may include and the piece of fabric 110. The apparatus 100 may further comprise a device configured to store the piece of fabric 110 when not in use. The device may be a storage reel 200. Further, the storage reel 200 may include a handle 210 configured to facilitate collecting the piece of fabric 110 onto the storage reel 200.

Upon reading this specification, it should be appreciated that, under appropriate circumstances, considering such issues as user preferences, design preference, structural requirements, marketing preferences, cost, available materials, technological advances, etc., other apparatus 100 arrangements such as, for example, means of utilizing the apparatus 100, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for use as a golf training aid, the apparatus comprising:
a piece of fabric, said piece of fabric having an elongate body with a first end and a second end;
a plurality of grommets, a first of said plurality of grommets located on said first end of said elongate body and a seventh of said plurality of grommets located on said second end of said elongate body;
wherein said elongate body defines a predetermined length;
wherein said elongate body includes a plurality of different colored segments;
wherein each of said plurality of different colored segments is configured to represent a different distance interval;
wherein each of said plurality of different colored segments is separated by a second, a third, a fourth, a fifth, and a sixth of said plurality of grommets; and
wherein said apparatus is configured to be used as a golf training aid and improve golfing skills.

2. The apparatus for use as a golf training aid of claim 1, wherein said apparatus further comprises a plurality of stakes, said plurality of stakes removably coupled to said plurality of grommets and configured to secure said piece of fabric to a portion of ground during use.

3. The apparatus for use as a golf training aid of claim 1, wherein said apparatus further comprises a device configured to store said piece of fabric when not in use.

4. The apparatus for use as a golf training aid of claim 3, wherein said device is a storage reel.

5. The apparatus for use as a golf training aid of claim 4, wherein said storage reel has a handle configured to facilitate collecting said piece of fabric onto said storage reel.

6. The apparatus for use as a golf training aid of claim 1, wherein said piece of fabric comprises a polyester webbing.

7. The apparatus for use as a golf training aid of claim 1, wherein said piece of fabric has a width between about 1 inch and 3 inches.

8. The apparatus for use as a golf training aid of claim 1, wherein said predetermined length is between about 30 feet and 90 feet.

9. The apparatus for use as a golf training aid of claim 1, wherein said plurality of different colored segments comprises 6 different colored segments.

10. The apparatus for use as a golf training aid of claim 1, wherein said apparatus further includes a portable carrier configured to house said apparatus when not in use.

11. The apparatus for use as a golf training aid of claim 10, wherein said portable carrier has an attachment means configured to attached said portable carrier to a golf club carrier.

12. The apparatus for use as a golf training aid of claim 1, wherein said piece of fabric is made of polypropylene.

13. The apparatus for use as a golf training aid of claim 1, wherein said piece of fabric is made of nylon.

14. The apparatus for use as a golf training aid of claim 1, wherein said piece of fabric is UV-resistant.

15. The apparatus for use as a golf training aid of claim 1, wherein said piece of fabric is mold-resistant.

16. The apparatus for use as a golf training aid of claim 1, wherein said piece of fabric is weatherproof.

17. The apparatus for use as a golf training aid of claim 16, further comprising a set of instructions; and wherein the apparatus for use as a golf training aid is arranged as a kit.

18. An apparatus for use as a golf training aid, the apparatus comprising:
a piece of fabric, said piece of fabric having an elongate body with a first end and a second end;
a plurality of grommets, a first of said plurality of grommets located on said first end of said elongate body and a seventh of said plurality of grommets located on said second end of said elongate body;
wherein said elongate body defines a predetermined length;
wherein said elongate body includes a plurality of different colored segments;
wherein each of said plurality of different colored segments is configured to represent a different distance interval;
wherein each of said plurality of different colored segments is separated by a second, a third, a fourth, a fifth, and a sixth of said plurality of grommets;
wherein said apparatus is configured to be used as a golf training aid and improve golfing skills;
wherein said apparatus further comprises a plurality of stakes, said plurality of stakes removably coupled to said plurality of grommets and configured to secure said piece of fabric to a portion of ground during use;
wherein said apparatus further comprises a device configured to store said piece of fabric when not in use;
wherein said device is a storage reel;
wherein said storage reel has a handle configured to facilitate collecting said piece of fabric onto said storage reel;
wherein said piece of fabric comprises a polyester webbing;
wherein said piece of fabric has a width between about 1 inch and 3 inches;
wherein said predetermined length is between about 30 feet and 90 feet;
wherein said plurality of different colored segments comprises 6 different colored segments;
wherein said apparatus further includes a portable carrier configured to house said apparatus when not in use;
wherein said portable carrier has an attachment means configured to attached said portable carrier to a golf club carrier;
wherein said piece of fabric is UV-resistant;
wherein said piece of fabric is mold-resistant; and
wherein said piece of fabric is weatherproof.
